(19) United States
(12) Patent Application Publication
(10) Pub. No.: US 2012/0033675 A1
(43) Pub. Date: Feb. 9, 2012

(54) Dictation / audio processing system

(75) Inventor: Louis J. Talarico, JR., Shrewsbury, MA (US)

(73) Assignee: Scribe Technologies, LLC, Milford, DE (US)

(21) Appl. No.: 12/806,105

(22) Filed: Aug. 5, 2010

(51) Int. Cl. H04L 12/56; H04M 3/42; G06F 15/16

(52) U.S. Cl. 370/401; 709/219; 709/247; 379/201.01

(57) ABSTRACT

An audio handling system comprising audio file handling means for at least one of converting, compressing, encrypting, E-mailing, and pushing audio files to at least one of a file transfer protocol (FTP) site and at least one E-mail address.

### FIELD OF THE INVENTION

The present invention relates to file management systems and specifically to audio file processing systems.

### BACKGROUND OF THE INVENTION

Medical records formulation and maintenance have received additional attention recently with the passage of Federal U.S. healthcare legislation. Such medical records management includes, and requires, efficient and economical dictation and transcription capabilities for, for example, medical groups having numerous doctors as well as smaller practices and even solo doctor's offices.

Many current systems require, for example, complex server arrangements or an array of physical telephony cards for standard phone system usage and possess an incomplete ability to fully handle audio files.

### SUMMARY OF THE INVENTION

Accordingly, it is an object of the present invention to provide an improved dictation system.

Other objects will appear hereinafter.

It has now been discovered that the above and other objects of the present invention may be accomplished in the following manner. Specifically, in one exemplary embodiment of the present invention, an audio handling system is provided that comprises an audio file handling means for at least one of converting, compressing, encrypting, E-mailing, and pushing audio files to at least one of a file transfer protocol (FTP) site and at least one E-mail address.

In another exemplary embodiment of the present invention, an audio processing system is provided that comprises: a) a dictation server means for processing audio signals; b) audio signals input into the dictation server means; and c) processed audio signals from the dictation server into a main server means; for at least one of: i) conversion; compression; encryption; iv) E-mailing; and v) pushing files to at least one of a file transfer protocol (FTP) site and a client E-mail address.

### BRIEF DESCRIPTION OF THE DRAWINGS

The present invention will be more dearly understood from the following description taken in conjunction with the accompanying drawings in which like reference numerals designate similar or corresponding elements, regions and portions and in which:

FIG. 1 is a schematic block diagram view of an exemplary embodiment of the present invention;

FIGS. 2A-2C are screen shots of forms for monitoring an audio processing server in accordance with other exemplary embodiments of the present invention; and

FIGS. 3A-3E are screen shots of forms for administering a user database in accordance with other exemplary embodiments of the present invention.

### DETAILED DESCRIPTION OF THE PREFERRED EMBODIMENT

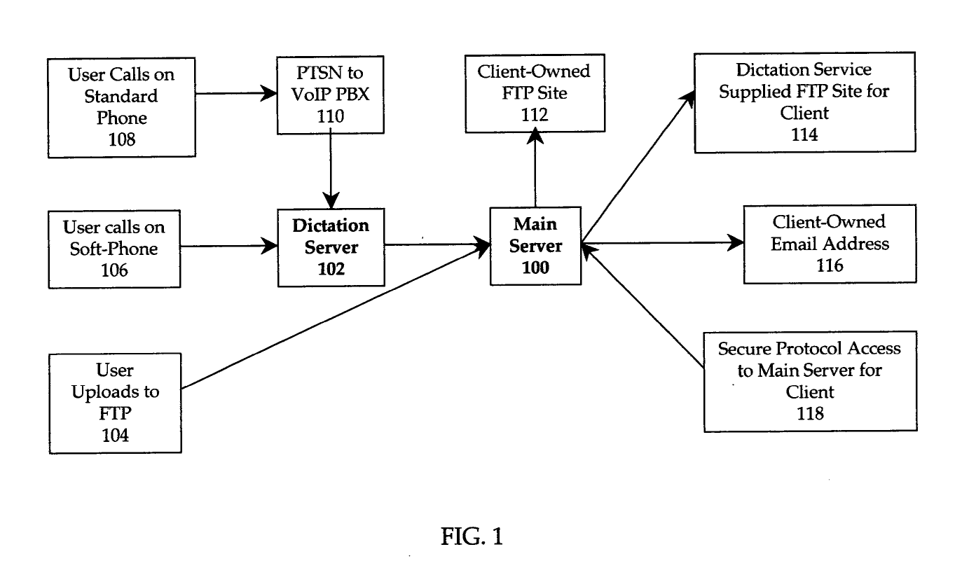

FIG. 1 is a schematic block diagram view of call/data flow capabilities of Dictation/Audio Processing System (“Dictation System”) 100 in accordance with an exemplary embodiment of the present invention. Specifically, Dictation System 100 includes Audio Processing Server 107 that receives: a) audio files from Dictation Server 106 (the phone-in server) and/or b) User Uploads to FTP 109 (File Transfer Protocol). Dictation System 100 also provides secure protocol access to processed audio files residing on Audio Processing Server 107 by a client through Secure Protocol Access to Audio Processing Server for Client 110.

Audio Processing Server 107 may be developed from scratch with a Visual Basic® application layer, and a MySQL® database layer. Audio Processing Server 107 pulls audio from Dictation Server 106 and FTP sites (e.g., User Uploads to FTP 109). A systematic routine may be used to, for example:

name files;

organize files in a meaningful hierarchy;

apply audio compression;

convert files from, for example, .voc to .mp3; encrypt files with, for example, 256-bit AES encryption;

upload the files to FTP sites (e.g., Client-Owned FTP Site 103 and/or Dictation Service Supplied FTP Site for Client 104 as illustrated in FIG. 1);

attach files to E-mail; and/or

send E-mail and text message (SMS) notifications of processed files (e.g., Client-Owned E-mail Address 108 as illustrated in FIG. 1) and provide special notification of STAT (urgent) files via E-mail and/or text message (SMS) notifications.

The file hierarchy generated by Audio Processing Server 107 may also be designed to be a foundation of an Internet-accessible vault of historical files that may easily be configured with commercially available server software (as would be recognized by one skilled in the art) to provide the files via, for example, secure websites HyperText Transfer Protocol Secure (HTTPS), File Transfer Protocol (FTP), Secure File Transfer Protocol (SFTP)/Secure Shell (SSH), or Virtual Private Network (VPN)—with such technologies being Internet based secure transfer protocols. Dictation System 100 of the present invention, and such hierarchy, may have little technical limitation as to which protocols, or any such protocols developed hereafter, to implement. Further, any combination of any such protocols, or all of the protocols, may be used to access the main file hierarchy. Thus, in accordance with Dictation System 100 of the present invention, files need not be replicated for each protocol, nor is any significant programming required to provide access to the files via such numerous protocols.

Dictation Server 106 is combined with a VoIP—(Voice over Internet Protocol) based PBX (Private Branched Exchange) that connects with the Public Switched Telephone Network (PSTN) (e.g., PSTN to VoIP PBX 102). User Calls on Standard Phone 101 (e.g., land lines in client's users offices, homes or businesses, or cell phones) may thus be processed through PSTN to VoIP PBX 102 within Dictation Server 106, while User Calls on Soft-Phone 105 may be directly accessed into Dictation Server 106, bypassing PSTN to VoIP PBX 102.

The Public Switched Telephone Network (PSTN) is the standard phone system that has been used in the United States for decades. Many voicemail/dictation products currently available range from using simple tape recorders to digital server based systems, and most are limited by, for example, requiring a physical telephony card (e.g., a piece of hardware that plugs into a computer's motherboard used to make/receive phone calls over the PSTN) for each phone line, as they don't have PBX call management or a PBX-to-PSTN connection, etc. Dictation System 100 may enable inexpensive telecommunications over the standard phone system (PSTN), and further, may be scaled to handle simultaneous calls (e.g., User Calls on Standard Phone 101) without requiring physical telephony cards. PSTN-to-VoIP connections may be added and configured to route calls from the PBX to Dictation Server 106 through PSTN-to-VoIP PBX 102.

Further, with VoIP as the core telephony protocol in Dictation System 100, users may be enabled to dictate into Dictation Server 106 with a soft-phone (e.g., a piece of computer software designed to make phone calls over the internet using SIP™ (Session Initiation Protocol), Skype®, or other such protocols) (e.g., User Calls on Soft-phone 105). Such a soft-phone user needs only a soft-phone and a given address for Dictation Server 106 that may look similar to an E-mail address. Dictation System 100 may work much like buying a domain name and having a web server and without the need for Skype®, Google Talk®, Gizmo® or other VoIP intermediaries. Thus, calls that come through User Calls on Soft-Phone 105, for example, may cost virtually nothing and the number of concurrent calls is limited only by the bandwidth allotted to Dictation Server 106. Incoming calls via User Calls on Standard Phone 101 (and through PSTN-to-VoIP 102), or User Calls on Soft-Phone 105 may use identical technology by the time they reach Dictation Server 106, so Dictation System 100 may be fundamentally integrated at that level. Audio generated by users who choose to upload files directly via FTP (e.g. from their own voice recorder) (e.g., User Uploads to FTP 109) are integrated by Audio Processing Server 100.

In one exemplary embodiment, the process and bandwidth load on Audio Processing Server 107 may be relatively much greater than on Dictation Server 106. Such exemplary design may allow a degree of scalability, as Audio Processing Server 107 may be replicated for load balancing between a single Dictation Server 106 and many other such Audio Processing servers. The design of Audio Processing Server 107 may permit unification of the data source of client information at the database level, while diverting process and bandwidth intensive functions to other multiple Audio Processing Servers, thus reducing administrative requirements and their associated costs.

It is noted that Dictation Server 106 and Audio Processing Server 107 may also be part of a single major piece of software.

Audio Processing Server 107

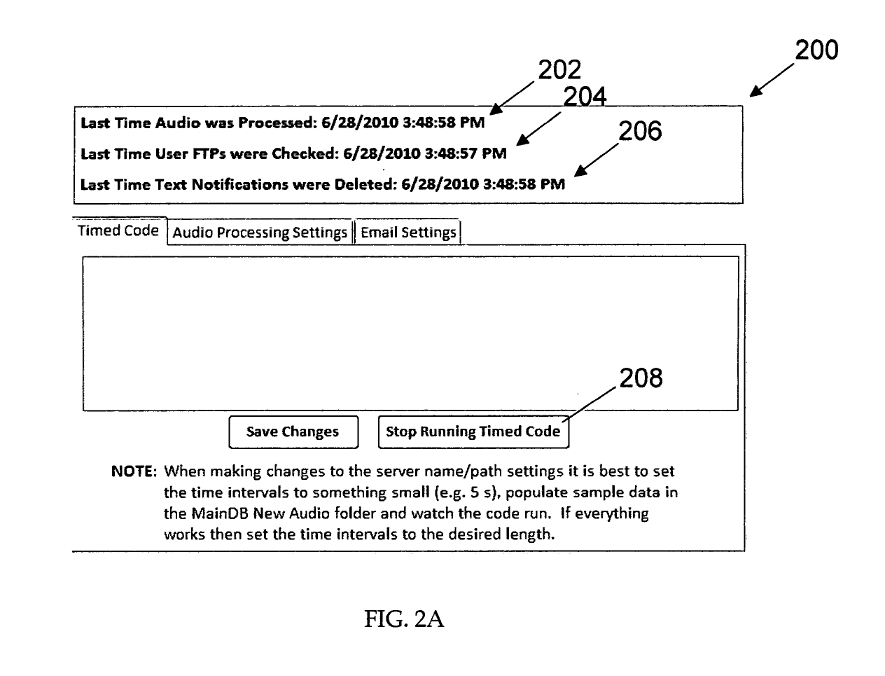

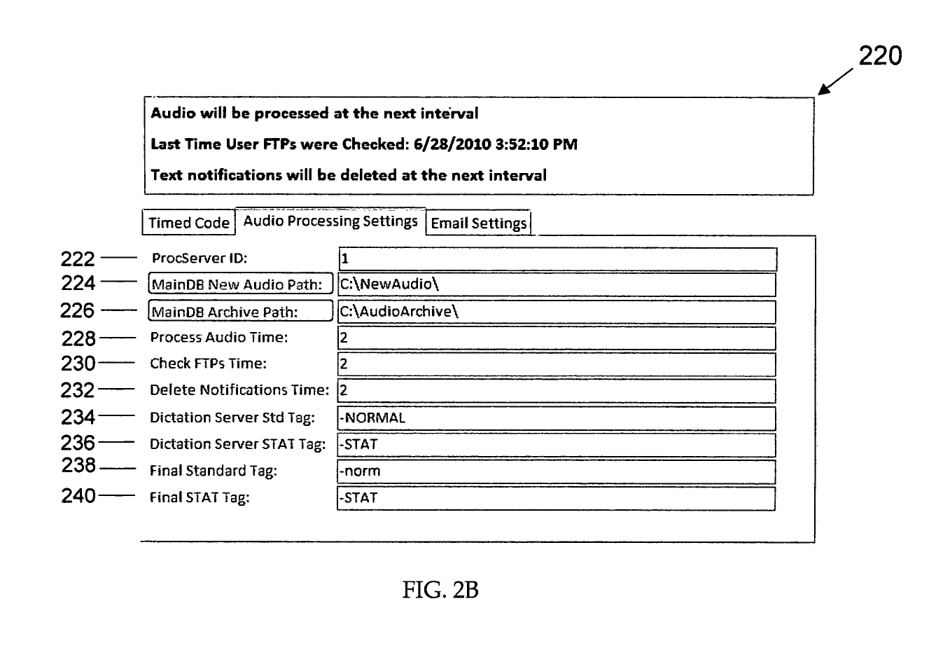

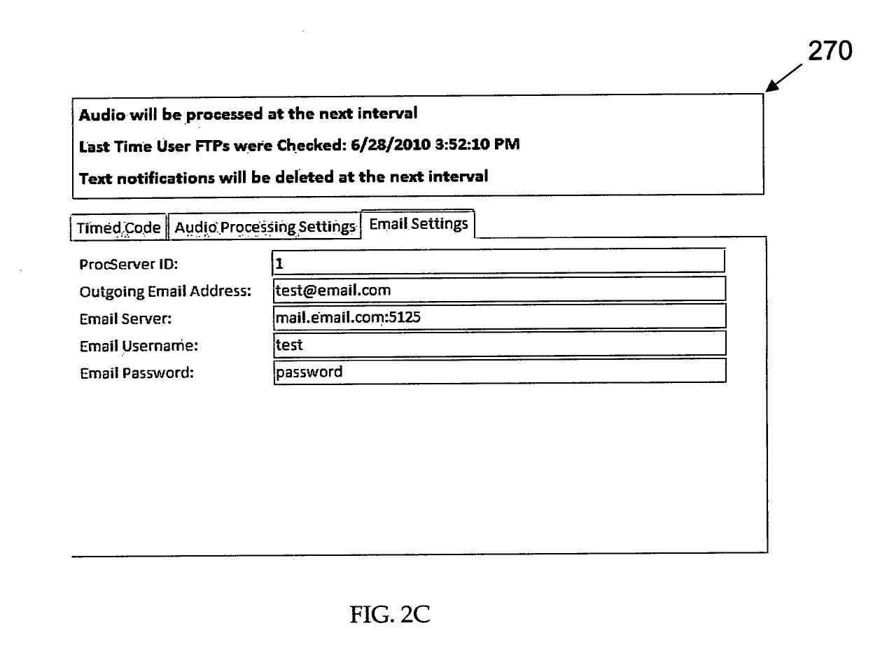

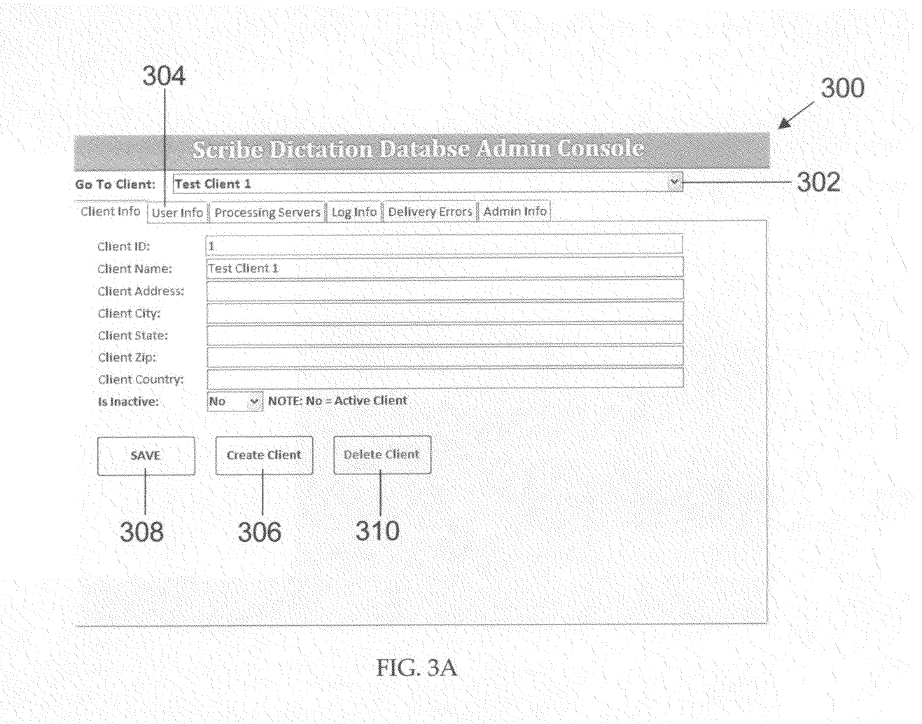

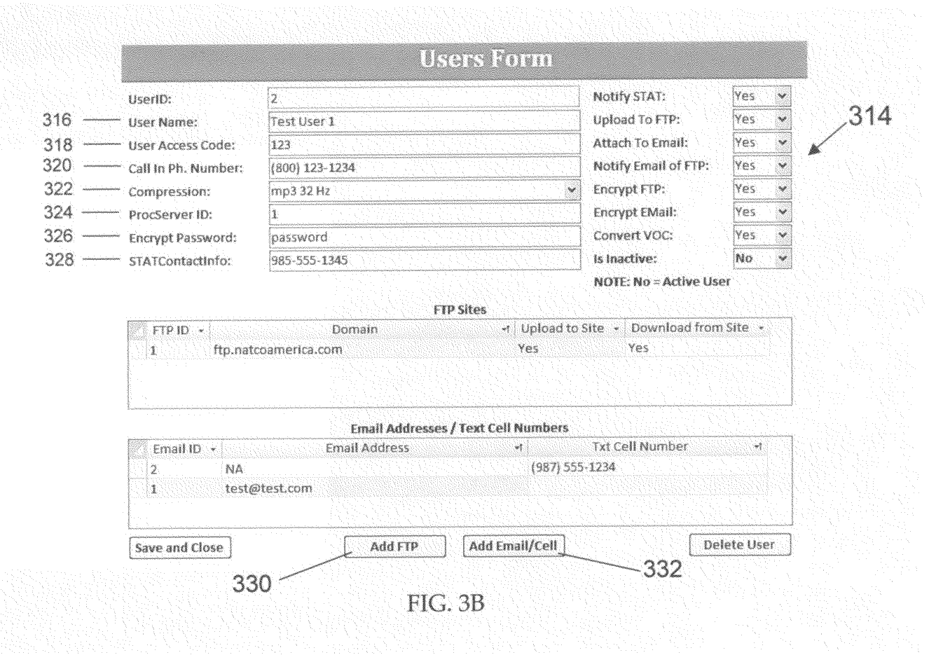

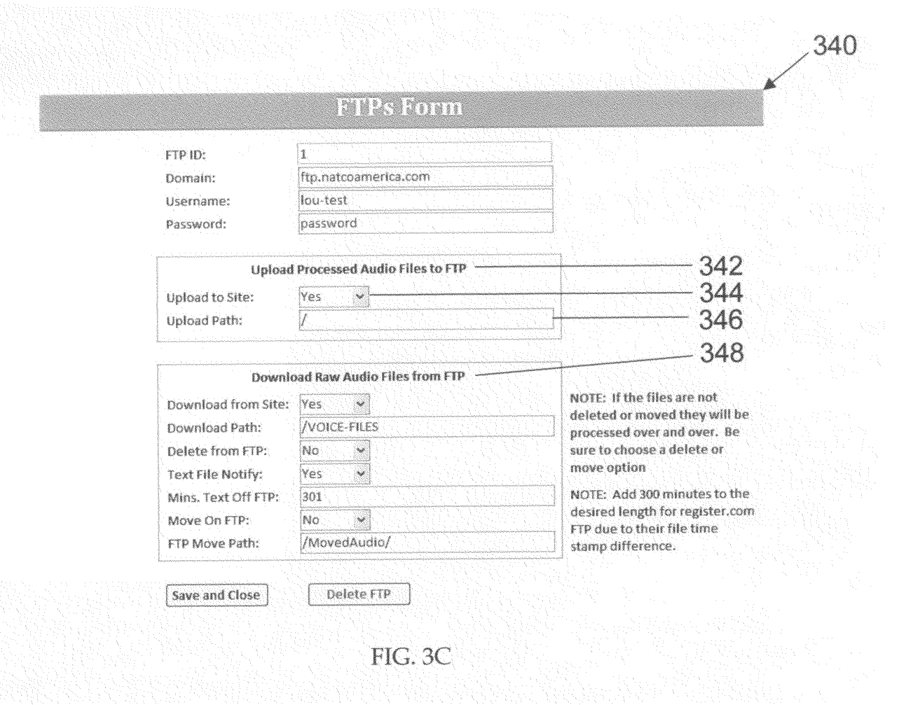

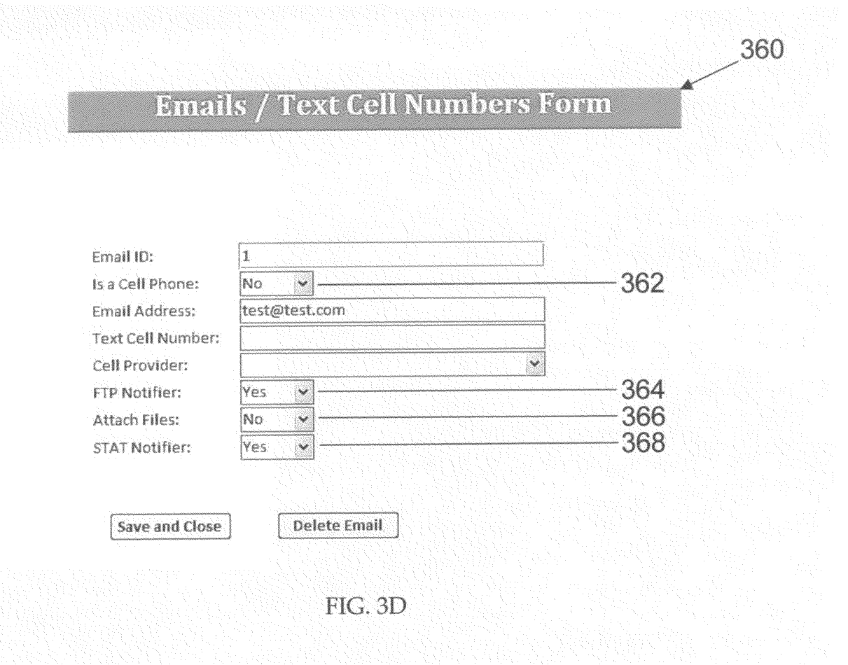

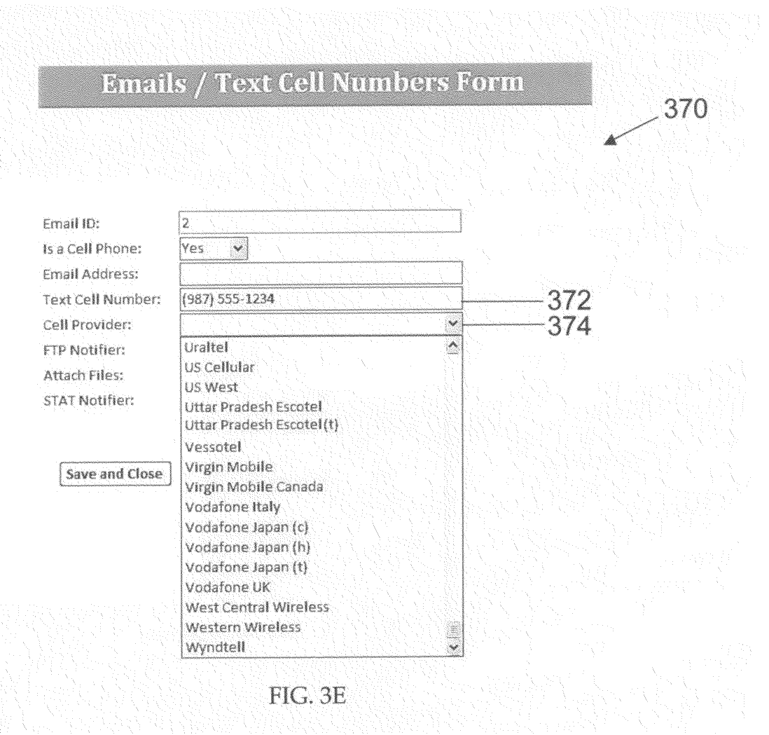

FIGS. 2A-2C and 3A-3E represent components of an exemplary user interface in which the Dictation System 100 of the present invention may be monitored and managed. Another possible user such interface may be through a World Wide Web interface and other user interfaces may also be developed to monitor and manage the present invention and the present invention is not limited to the specific interface shown and described herein.

FIG. 2A illustrates a screen shot of a relatively simple form, Time Audio Processing Code Form 200 for monitoring Audio Processing Server 107 in accordance with another exemplary embodiment of the present invention. Behind Form 200 is a large amount of code that may be timed to execute at different user defined time intervals. Setting such code to run at time intervals allows data to be pulled from user FTP sites (e.g., User Uploads to FTP 109) or from Dictation Server 106. One block of code may execute to pull audio files out of Dictation Server 106 and another block of code may execute to pull audio off user FTP sites (e.g., User Uploads to FTP 109). The code may be separated to allow setting different time intervals for the different functions. This allows load balancing of Audio Processing Server 107 depending on how many users use FIT (e.g., User Uploads to FTP 109) versus phone-in (e.g., User Calls on Standard Phone 101, and User Calls on Soft-Phone 105) (these functions also consume bandwidth at different rates). Time Stamps 202, 204, 206 indicating when audio processing functions have last been executed (shown as the top three lines of text) are automatically generated for easy monitoring. The code may be halted for database changes/maintenance by clicking Stop Running Timed Code Button 208.

FIG. 2B illustrates a screen shot of Audio Processing Settings Form 220 for Audio Processing Server 107. ProcServer ID 222 indicates the instance of Audio Processing Server 107 (recall that the present invention allows multiple instances of Audio Processing Server 107 for every Dictation Server 106 to allow for load balancing). MainDB New Audio Path 224 is a place where the computer file system path may be chosen for the location where incoming audio from User Calls on Standard Phone 101, User Calls on Soft-Phone 105 and User Uploads to FTF 109, for example, are temporarily stored before they are processed. Main DB Archive Path 226 is a field where the computer file system path may be chosen for the location of the archive of audio files that Audio Processing Server 107 has completed processing. Process Audio Time 228 is a field where the time (in seconds) may be chosen for Audio Processing Server 107 to process new audio signals. Check FTPs Time 230 is a field where the time (in seconds) may be chosen for Audio Processing Server 107 to scan FTP sites (from User Uploads to FTP 109). Audio Processing Server 107 has the ability to put a small text file on user FTP sites (from User Uploads to FTP 109) for each audio file that it downloads from a given user FTP site indicating that an audio file was removed. Audio Processing Server 107 can also remove the text notification after a user-defined amount of time. Delete Notifications Time 232 is a field where the time (in seconds) may be chosen for Audio Processing Server 107 to check if it is time for text notifications to be deleted. Audio Processing Server 107 may add and remove character tags to audio file filenames as it processes audio files. Some of the character tags may be defined at the level of the instance of Audio Processing Server 107 in the bottom four fields 234, 236, 238, 240 on FIG. 2B.

The organization administering Audio Processing Server 107 may supply Audio Processing Server 107 with an E-mail address from which E-mails to users will be sent. FIG. 2C illustrates the E-mail address and related E-mail server settings Form 270 of the organization administering Audio Processing Server 107. These are standard E-mail settings that may be recognized by one skilled in the art and no detailed explanation is believed needed.

The present invention may have a database associated with it that contains all of the client and user settings that indicate to Audio Processing Server 107 how to process audio files for the user. This database may be designed to have one “client” with many “users” of the system (in a one-to-many relationship in the database). A client may be analogous to, for example, a Medical Transcription Service Organization, and a user may be analogous to, for example, a doctor creating dictation. When so referenced in the following descriptions of FIGS. 3A-3E (screen shots of Forms 300, 314, 340, 360, 370 that may be used to monitor and administer the database in accordance with other exemplary embodiments of the present invention), when something is described as happening at the client level versus the user level, it reflects this relationship.

FIG. 3A illustrates a screen shot of Form 300 having specific client level information, with navigation from one client to another client enabled by using Go To Client Pull Down Box 302. Once a client is selected, all the users associated with that client will appear in a list on User Info tab 304. A new client may be added by clicking Create Client button 306, a new or existing client's information may be saved by clicking on Save button 308, and an existing client's information (client) may by deleted by clicking Delete Client button 310.

Detailed user information may be accessed from the list of users that appear on User Info tab 304 (screen shot of User Info tab 304 being selected is not shown). The User Info tab 304 also may include buttons for common database tasks for adding and deleting users and saving data.

FIG. 3B illustrates a screen shot of Form 314 showing detailed user information. Most of the flexibility of the present invention may be seen at the user level as will be discussed in detail below, and it is contemplated that single clients may be allowed to make mass edits to user level data. This may achieve a good combination of flexibility and ease of administration. Note that many of the simple selections made at the user level trigger different blocks of computer code in Audio Processing Server 107 that is the basis of the flexibility of Dictation System 100. User Name field 316 contains a name for the user that is unique for the associated client. User Access Code field 318 contains the unique code that a user must enter when performing phone-in dictation so that the user may be uniquely identified. Call In Ph. Number field 320 is an optional field that may contain the number that user calls for phone-in dictation. Compression field 322 is a pull down box that allows the user to select an audio file compression setting. Audio Processing Server 107 may be configured to compress raw .wav audio files into, for example, .mp3 files. The compressed files may be compressed at different sampling rates. FIG. 3B illustrates, for example, mp3 compression at a sampling rate of 32 Hz.

ProcServer ID field 324 is a field that indicates which instance of Audio Processing Server 107 should be used to process a given user's audio files. Audio Processing Server 107 may be configured to encrypt files using, for example, 256 bit AES encryption. The files may be encrypted with a password that can be designated in Encrypt Password field 326. Audio Processing Server 107 may be configured to send special notification of STAT files as described above. STAT Contact Info field 328 is a field where a custom message may be included in the STAT notification.

The Yes/No pull down boxes on the right side of FIG. 3B provide additional user level options for indicating how Audio Processing Server 107 should process audio files and are believed to be self-explanatory to one skilled in the art. Notify STAT indicates if Audio Processing Server 107 should send STAT notifications for a given user. Upload to FTP indicates if Audio Processing Server 107 should upload audio files to FTP sites for a given user. Attach to E-mail indicates if Audio Processing Server 107 should attach audio files to E-mail for a given user. Note that the specific FTP sites and E-mail addresses that Audio Processing Server 107 will use to send the files can be designated in the bottom two sections of FIG. 3B and will be discussed in detail below.

Notify E-mail of FTP indicates if Audio Processing Server 107 should send an E-mail notification when audio files are uploaded to an FTP for a given user. Encrypt FTP indicates if Audio Processing Server 107 should encrypt the audio files that it uploads to FTP sites for a given user. Encrypt E-mail indicates if Audio Processing Server 107 should encrypt the audio files that it E-mails for a given user. It is contemplated that another small stand alone “wrapper” application around the encryption software may be created for users so that they may password protect each file during transmission and mass decrypt them once the files are downloaded. Audio Processing Server 107 may be configured to convert audio files from, for example, .voc to .mp3. Audio Processing Server 107 may be configured to convert to and from other audio formats as well. Convert VOC indicates if Audio Processing Server 107 should .voc files to .mp3 for a given user.

Zero, one or many: FTP sites; E-mail addresses; and cell phone numbers (for SMS messaging) may be associated with each user. FTP sites, E-mail addresses and cell phone numbers may be added to a given user with Add FTP button 330 and Add E-mail/Cell button 332 at the bottom of Form 314. In this particular user interface, as FTPs are added they appear as entries under the FTP Sites section of FIG. 3B, and, as E-mail addresses or cell phone numbers are added, they appear as entries under the E-mail Addresses/Text Cell Numbers section of FIG. 3B. Clicking on a specific entry under FTP Sites will bring up details about the FTP site. Similar functionality exists in this particular user interface for E-mail addresses and cell phone numbers. The FTP detail is illustrated in FTPs Form 340 illustrated in FIG. 3C and the E-mail/cell phone detail is illustrated in Forms 360, 370 illustrated, respectively, in FIGS. 3D-3E. Note that in this particular user interface, E-mail and cell phone functionality was combined on one form because Audio Processing Server 107 handles E-mails and SMS messages in a similar fashion, but this represents neither a fundamental requirement, nor limitation, of Audio Processing Server 107.

FIG. 3C illustrates a screen shot of FTPs (user FTPs sites) Form 340. Each FTP entry in the database may have expected connection information (i.e. Username, Password, Domain) used by Audio Processing Server 107 that may be entered at the top of the FTPs Form 340. Upload Processed Audio Files to FTP section 342 includes Upload to Site field 344 (pull down box), which indicates to Audio Processing Server 107 if a given FTP site should be use for upload of processed audio files. This section of the form also includes Upload Path 346, which is the directory path on the FTP that Audio Processing Server 107 may use as the location on the FTP to put the files. Download Raw Audio Files from FTP section 348 includes features of this particular user interface that may be used by Audio Processing Server 107 to designate a given FTP site as the one from which to download new audio (i.e., audio from User Uploads to FTP 109).

Audio Processing Server 107 may download file(s) and leave a copy in the same location on the FTP, download file(s) and move the downloaded file(s) to a different location on the FTP, or download file(s) and delete the file(s) from the FTP. If the files are deleted from the FTP, Audio Processing Server 107 can be configured to place a small text file in the same location that the audio file was located, indicating that the file was successfully downloaded and removed. Audio Processing Server 107 may also delete the text file notification after a user-defined amount of time. Download Raw Audio Files from FTP section 348 of Form 340 contains fields that may be used by Audio Processing Server 107 to accomplish each of the aforementioned functions for a given FTP site.

FIG. 3D illustrates Emails/Text Cell Numbers Form 360 and includes a Yes/No pull down box for Is a Cell Phone field 362 within which it is indicated if this database entry represents either a cell phone (yes) or E-mail (no). Note that in this particular user interface, the fields that are irrelevant for cell phones may become darkened when Is a Cell Phone field 362 is set to Yes and the fields irrelevant for E-mails become darkened when Is a Is a Cell Phone field 362 is set to No. FTP Notifier field 364 indicates if a given E-mail should be used for FTP notifications by Audio Processing Server 107. Attach Files field 366 indicates if a given E-mail should be used to deliver audio files by way of an attachment by Audio Processing Server 107. STAT Notifier field 368 indicates if a given E-mail should be used to notify when STAT files are created by Audio Processing Server 107.

FIG. 3E illustrates a screen shot of Emails/Text Cell Numbers Form 370 that may be used for creating a cell phone entry in the database. Text Cell Number field 372 is a field within which a text cell number is entered so that Audio Processing Server 107 may send an SMS message. Audio Processing Server 107 currently may support every major national cell carrier in the United States (e.g., Sprint®, Verizon®, AT&T, Nextel®, T-Mobile®, MetroPCS®, Boost Mobile®, etc.) and over 130 regional and international carriers. Additional cell providers may be added easily depending on their SMS technology. Cell Provider field 374 is a field Audio Processing Server 107 may use to determine which service provider is associated with the text cell phone number designated in field 372. Audio Processing Server 107 may include the audio filename, User Name and STAT Call Back field contents in the SMS message.

As disclosed, Dictation System 100 is designed to be extendible. For example, Dictation System may have hundreds of clients, each with hundreds of users, and each user could have hundreds of FTP sites and hundreds of E-mail addresses with virtually every optional feature enabled. For practical reasons, and as a business decision, it may make sense to limit these options, but there are no fundamental technical limitations within Dictation System 100 of the present invention from so doing.

Dictation Server 106

Dictation Server 106 (e.g., see FIG. 1) is primarily code-based and may handle over 5,000 users and roughly 100 concurrent VoIP connections although such limits may increase. It may support numerous dictation types, and is currently configured for standard and STAT dictation types. The menu audio and the menu functions and key assignments may be highly customizable. Additionally, numerous instances of Dictation System 100 may be created to accommodate a virtually unlimited number of users.

Dictation Server 106 may support multiple audio files being created from a single phone call. Play, rewind, fast forward, go to beginning, go to end, and record overwrite from current position may all be supported. The maximum audio length is unlimited with respect to Dictation Server 106 itself (hard disk space, the Windows® Operating System or other operating systems employed, etc. may impose limitations on file size), and there may be unlimited files per each call. This offers an extremely high level of scalability, and the server may be easily replicated as many times as necessary to handle increasing call volumes.

In brief summarization, Dictation System 100 of the present invention may receive a audio files via a phone-in system and/or direct user upload and do any or all of the following: compress, encrypt, E-mail, push to FTP, etc., (e.g., see above) automatically based on user specifications. Alterations of the present invention may be made within the scope and teachings of the invention. For example, the forms illustrated herein may have additional or less fields, pull down boxes, check boxes, etc., and the current such choices or alternated choices may be rearranged/arranged in a manner different than that shown while remaining within the teachings of the present invention.

While particular embodiments of the present invention have been illustrated and described, it is not intended to limit the invention, except as defined by the following claims.

I claim:

1. An audio handling system, the system comprising audio file handling means for at least one of converting, compressing, encrypting, E-mailing, and pushing audio files to at least one of a file transfer protocol (FTP) site and at least one E-mail address.

2. The audio handling system of claim 1, wherein the audio filing handling means automatically converts, compresses, encrypts, E-mails, and/or pushes audio files based upon predetermined specifications.

3. The audio handling system of claim 1, wherein the audio file handling means converts, compresses, encrypts, E-mails, and/or pushes audio files to a file transfer protocol (FTP) site.

4. The audio handling system of claim 1, wherein the audio file handling means converts, compresses, encrypts, E-mails, and pushes audio files to at least one E-mail address.

5. The audio handling system of claim 1, further comprising:
a dictation server means for processing audio signals.

6. The audio handling system of claim 5, further comprising:
audio signals input into the dictation server means.

7. The audio handling system of claim 1, further comprising:
a dictation server means for processing audio signals, and
audio signals input into the dictation server means.

8. An audio processing system, the system comprising:
a) a dictation server means for processing audio signals;
b) audio signals input into the dictation server means; and
processed audio signals from the dictation server into a main server means for at least one of
a. conversion,
b. compression,
c. encryption,
d. E-mailing, and
e. pushing
files to at least one of a file transfer protocol (FTP) site and a client E-mail address.

9. The audio processing system of claim 8, wherein the processed audio signals from the dictation server into a main server means for at least one of
a. conversion,
b. compression,
c. encryption,
d. E-mailing, and
e. pushing
files to a file transfer protocol (FTP) site.

10. The audio processing system of claim 8, wherein the processed audio signals from the dictation server into a main server means for at least one of
a. conversion,
b. compression,
c. encryption,
d. E-mailing, and
e. pushing
files to a client E-mail address.

11. The audio processing system of claim 8, wherein the main server means pulls files from the FTP site.

12. The audio processing system of claim 8, wherein the audio signals originate from a user call on a soft-phone or a standard phone.

13. The audio processing system of claim 12, wherein the audio signals originating from a user call on a standard phone are routed through a public telephone switched network (PTSN) to voice over internet protocol (VoIP) private branched exchange (PBX).

14. The audio processing system of claim 8, wherein the FTP site is a client owned FTP site.

15. The audio processing system of claim 8, wherein the FTP site is a dictation service supplied FTP site.

16. The audio processing system of claim 8, further comprising secure protocol access means for accessing the main server.
